(19) United States
(12) Patent Application Publication
(10) Pub. No.: US 2021/0370695 A1
(43) Pub. Date: Dec. 2, 2021

(54) LIQUID DISCHARGE DEVICE

(71) Applicant: BROTHER KOGYO KABUSHIKI KAISHA, Nagoya-shi (JP)

(72) Inventor: Tetsuo ITO, Nagoya-shi (JP)

(21) Appl. No.: 17/207,187

(22) Filed: Mar. 19, 2021

(30) Foreign Application Priority Data
May 29, 2020 (JP) 2020-094914

(51) Int. Cl. B41J 25/308; B41J 25/00

(52) U.S. Cl. CPC B41J 25/3082; B41J 25/001

(57) ABSTRACT

A printer is provided with a front linear guide rail, a front linear guide block, a rear linear guide rail, a rear linear guide block, and a carriage. The front linear guide rail extends in a first direction. The front linear guide block is configured to move along the front linear guide rail. The rear linear guide rail is provided in a second direction with respect to the front linear guide rail, and extends in the first direction. The rear linear guide block is configured to move along the rear linear guide rail. The carriage is fixed to the front linear guide block and the rear linear guide block. One of the front linear guide block and the rear linear guide block positions the carriage in the second direction, and the other positions the carriage in a third direction.

### CROSS-REFERENCE TO RELATED APPLICATION

This application claims priority to Japanese Patent Application No. 2020-094914 filed May 29, 2020. The contents of the foregoing application are hereby incorporated herein by reference.

### BACKGROUND

The present disclosure relates to a liquid discharge device.

A liquid discharge device that discharges a liquid such as ink or a discharge agent from a head onto a medium is known. An inkjet recording device is provided with a pair of guide rails, a carriage, and a head. Each of the pair of guide rails extends in a scanning direction of the carriage. An engagement portion is provided on each of the pair of guide rails. The engagement portions engage with the guide rails, respectively, so as to be able to move along the pair of guide rails. The carriage is fixed to each engagement portion, and mounts the head. The head prints an image by discharging ink onto a medium.

### SUMMARY

In the inkjet recording device described above, the two engagement portions are both engaged from above with the pair of guide rails. Therefore, the carriage may move in the up-down direction with respect to the guide rails due to looseness between the engagement portions and the guide rails or the like. If the carriage moves in the up-down direction with respect to the guide rails, the distance between the head and the medium will change. Therefore, the actual position where the ink lands on the medium may deviate from the ink landing target.

Embodiments of the broad principles derived herein provide a liquid discharge device capable of inhibiting the actual position where a liquid lands on a medium from deviating from a liquid landing target.

A liquid discharge device includes a first rail extending in a first direction, a first block configured to move along the first rail, a second rail provided in a second direction orthogonal to the first direction with respect to the first rail and extending in the first direction, a second block configured to move along the second rail, and a carriage fixed to the first block and the second block and provided with a head configured to discharge a liquid onto a medium, wherein one of the first block and the second block positions the carriage in the second direction, and wherein the other of the first block and the second block positions the carriage in a third direction orthogonal to the first direction and the second direction.

According to this aspect, the carriage is positioned in the second direction and the third direction by the first block and the second block. Therefore, when the carriage moves in the first direction, the carriage is inhibited from moving in the second direction and the third direction with respect to the first rail and the second rail. Accordingly, the liquid discharge device can inhibit the actual position where the liquid lands on the medium from deviating from the liquid landing target.

### BRIEF DESCRIPTION OF THE DRAWINGS

Embodiments will be described below in detail with reference to the accompanying drawings in which:

FIG. 1 is a perspective view of a printer;

FIG. 2 is a perspective view showing the internal structure of the printer;

FIG. 3 is a plan view showing the internal structure of the printer;

FIG. 4 is a sectional view of a carriage and a guide shaft taken along arrow IV-IV in FIG. 3, with a head removed; and

FIG. 5 is a perspective view of the guide shaft with the carriage removed.

### DETAILED DESCRIPTION

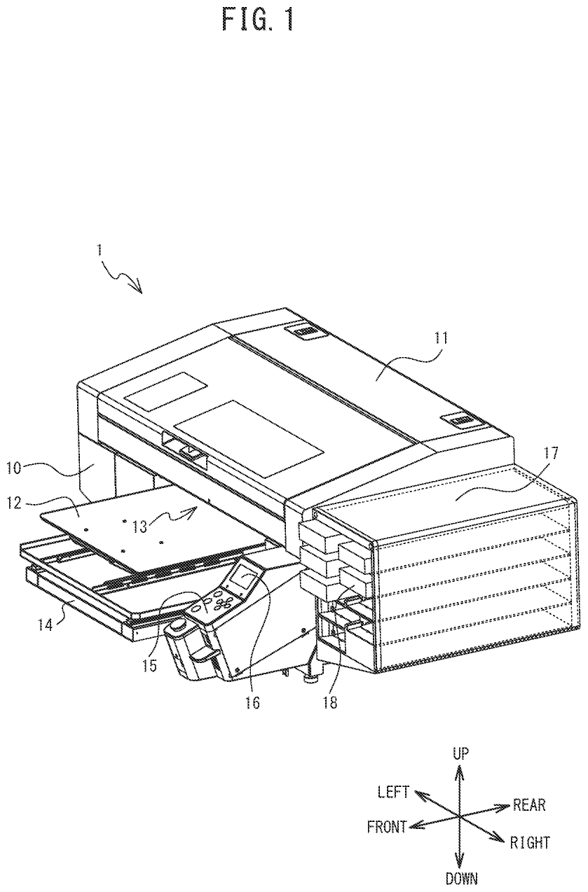

A printer 1 related to one embodiment of the present disclosure will be described with reference to the drawings. The directions of up, down, lower left, upper right, lower right, and upper left in FIG. 1 correspond to the upper side, lower side, front, rear, right, and left, respectively, of the printer 1. The up-down direction in FIG. 1 is the vertical direction. In the present embodiment, the mechanical elements in the drawings are shown at actual scale.

The printer 1 shown in FIG. 1 is an inkjet printer, and performs printing by discharging ink onto a print medium of cloth or paper or the like. The printer 1 can print a color image on the print medium using five colors of ink, i.e., white, black, yellow, cyan, and magenta.

Hereinafter, of the five colors of ink, the white-colored ink will be referred to as “white ink”, and the other four colors of ink, i.e., black, cyan, yellow, and magenta, will collectively be referred to as “color ink”. When collectively referring to the white ink and the color ink, or when neither is specified, they will simply be referred to as “ink”. The white ink is used for printing as a white part of an image or as a base for inks of other colors. The color ink is used for printing a color image and is discharged directly onto the print medium or onto a base of white ink.

The outer structure of the printer 1 will now be described referring to FIG. 1. The printer 1 includes a case 10 and a lid 11. The case 10 is U-shaped when viewed from the front. An opening 13 is formed in the case 10. The opening 13 extends from the front side of the case 10 rearward. The lid 11 is provided on the upper side of the case 10, and is able to be opened to a position where the upper side of the case 10 is open, and closed to a position where the upper side of the case 10 is covered, by being rotated with the rear end of the lid 11 as the axis.

Operating buttons 15 and a display screen 16 are provided on the right side of the opening 13 on the front surface of the case 10. The operating buttons 15 input various information to the printer 1 in accordance with an operation by an operator. The display screen 16 displays various information. Therefore, the operator operates the printer 1 from the front side of the printer 1. That is, in the present embodiment, the front side of the printer 1 is the front of the printer 1.

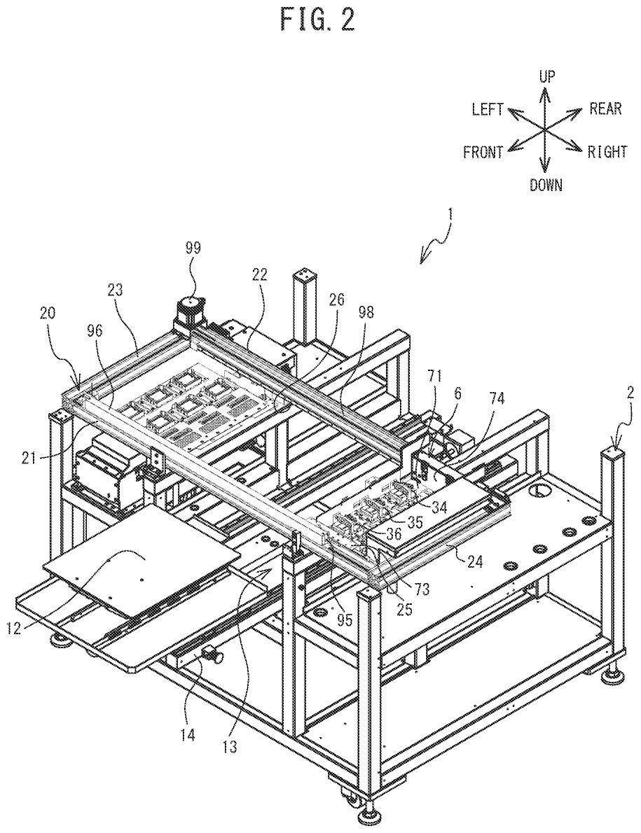

A platen 12 is disposed in the opening 13. The platen 12 has a plate shape, and is supported from below by a support portion 14 so as to be able to move in the front-rear direction. The support portion 14 is fixed to a frame body 2 shown in FIG. 2 inside the opening 13. The platen 12 moves in the front-rear direction by the driving of a sub-scanning motor (not shown in the drawings). Therefore, in the present embodiment, the front-rear direction is the sub-scanning direction.

The platen 12 can protrude farther forward than the front surface of the case 10, i.e., forward of a front shaft 21, by moving forward, and can move farther rearward than a rear shaft 22 inside the case 10 by moving rearward. The operator arranges the print medium on the upper surface of the platen 12 while the platen 12 is protruding forward from the front of the case 10. An accommodation portion 17 is provided on the right side of the case 10. A plurality of cartridges 18 are placed in the accommodation portion 17 from the front side. The cartridges 18 contain various liquids such as ink used for printing.

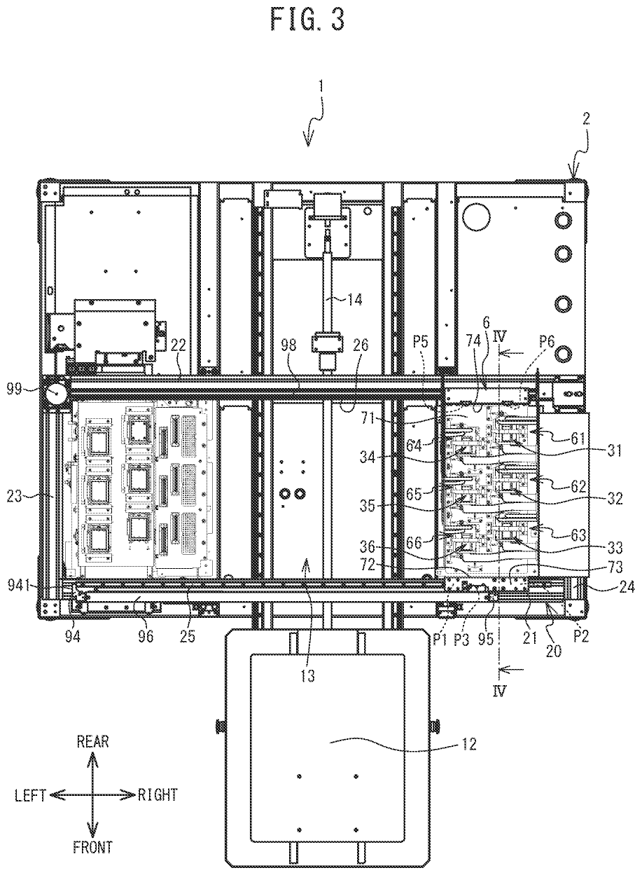

The internal structure of the printer 1 will now be described with reference to FIG. 2 and FIG. 3. As shown in FIG. 2, the frame body 2 is provided inside the case 10 shown in FIG. 1. The frame body 2 is formed in a lattice shape by a plurality of shafts extending in the front-rear direction, a plurality of shafts extending in the left-right direction, and a plurality of shafts extending in the up-down direction. A guide shaft 20 is fixed to the upper end of the frame body 2. The guide shaft 20 is formed by the front shaft 21, the rear shaft 22, a left shaft 23, and a right shaft 24.

The front shaft 21 is disposed on a front end portion of the frame body 2, and extends in the left-right direction from the left end portion to the right end portion of the frame body 2. The rear shaft 22 is disposed in substantially the center in the front-rear direction of the frame body 2, and extends in the left-right direction from the left end portion to the right end portion of the frame body 2. The left shaft 23 is disposed on the left end portion of the frame body 2, and extends in the front-rear direction from the left end of the front shaft 21 to the left end of the rear shaft 22. The right shaft 24 is disposed on the right end portion of the frame body 2, and extends in the front-rear direction from the right end of the front shaft 21 to the right end of the rear shaft 22.

The front shaft 21 and the rear shaft 22 support a carriage 6. The carriage 6 is a plate, which extends from the front shaft 21 to the rear shaft 22. As shown in FIG. 3, six mounting portions 61 to 66 are provided on the carriage 6. Each of the mounting portions 61 to 66 is a region where a head, described later, is to be mounted, and includes both an opening passing through the carriage 6 in the up-down direction, and an area around the opening. The shape of the mounting portions 61 to 66 when viewed from above corresponds to the outer shape of the heads when viewed from above.

The mounting portions 61, 62, and 63 are disposed on the right side of the carriage 6, and are lined up in a row from the rear side toward the front side in the order of the mounting portion 61, the mounting portion 62, and the mounting portion 63. The mounting portions 64, 65, and 66 are disposed on the left side of the row of the mounting portions 61, 62, and 63, and are lined up in a row from the rear side toward the front side in the order of the mounting portion 64, the mounting portion 65, and the mounting portion 66.

A head can be mounted to each of the mounting portions 61 to 66. FIG. 2 shows an example of a state in which heads are mounted to mounting portions, and shows a state in which heads 31 to 36 are mounted to the mounting portions 61 to 66, respectively. Below, the state shown in FIG. 2 is assumed.

White ink is supplied to each of the heads 31 and 34 from a white ink cartridge 18. A discharge agent is supplied from a discharge agent cartridge 18 to each of the heads 32 and 35. The discharge agent is a liquid for removing the color of the print medium. Color ink is supplied from color ink cartridges 18 to each of the heads 33 and 36.

As shown in FIG. 2 and FIG. 3, a drive belt 98 is connected to a rear end portion of the carriage 6. The drive belt 98 is provided on the rear shaft 22 and extends in the left-right direction. The left end portion of the drive belt 98 is connected to a main scanning motor 99. The main scanning motor 99 is provided on the upper side of the left end portion of the rear shaft 22. Driving the main scanning motor 99 causes the drive belt 98 to move the carriage 6 in the left-right direction along the front shaft 21 and the rear shaft 22. Therefore, in the present embodiment, the left-right direction is the main scanning direction. FIG. 2 and FIG. 3 show a state in which the carriage 6 is positioned on the right end of the moving range.

According to this structure, the printer 1 conveys the print medium in the front-rear direction and the left-right direction with respect to the heads 31 to 36 by causing the platen 12 to move in the front-rear direction (sub-scanning direction) by driving the sub-scanning motor (not shown in the drawings), and causing the carriage 6 to move in the left-right direction (main scanning direction) by driving the main scanning motor 99. The printer 1 discharges various liquids from the heads 31 to 36 while conveying the print medium in the front-rear direction and the left-right direction with respect to the heads 31 to 36. More specifically, the printer 1 first discharges the discharge agent from the heads 32 and 35 to remove color from the print medium. Alternatively, the printer 1 first discharges white ink from the heads 31 and 34 to form a base on the print medium. The printer 1 prints a color image by discharging color ink from the heads 33 and 36 on the portion of the print medium where color was removed or onto the base that was formed. Note that the printer 1 may discharge both the white ink and the discharge agent.

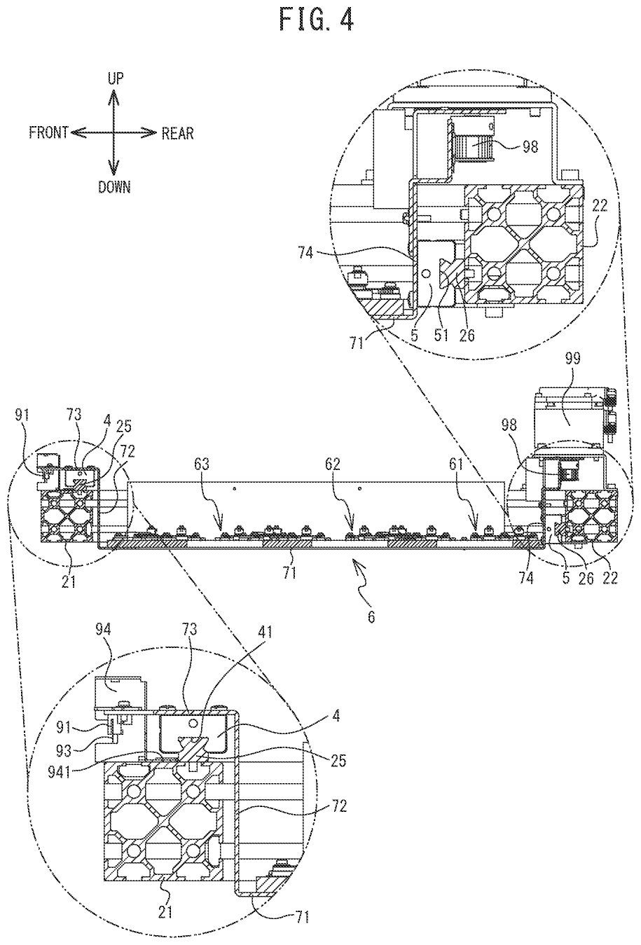

The specific structure of the carriage 6 will be described with reference to FIG. 3 and FIG. 4. The carriage 6 is provided with a support plate 71, a front extension plate 72, a front fixing plate 73, and a rear fixing plate 74. The support plate 71 has a rectangular shape when viewed from above, and extends from the rear side of the front shaft 21 to the front side of the rear shaft 22, in substantially the same position as the lower ends of the front shaft 21 and the rear shaft 22 in the up-down direction. The mounting portions 61 to 66 are provided on the support plate 71.

As shown in FIG. 4, the front extension plate 72 extends upward from the front end of the support plate 71 to above the upper end of the front shaft 21. The front fixing plate 73 extends forward from the upper end of the front extension plate 72. The rear fixing plate 74 extends upward from the rear end of the support plate 71.

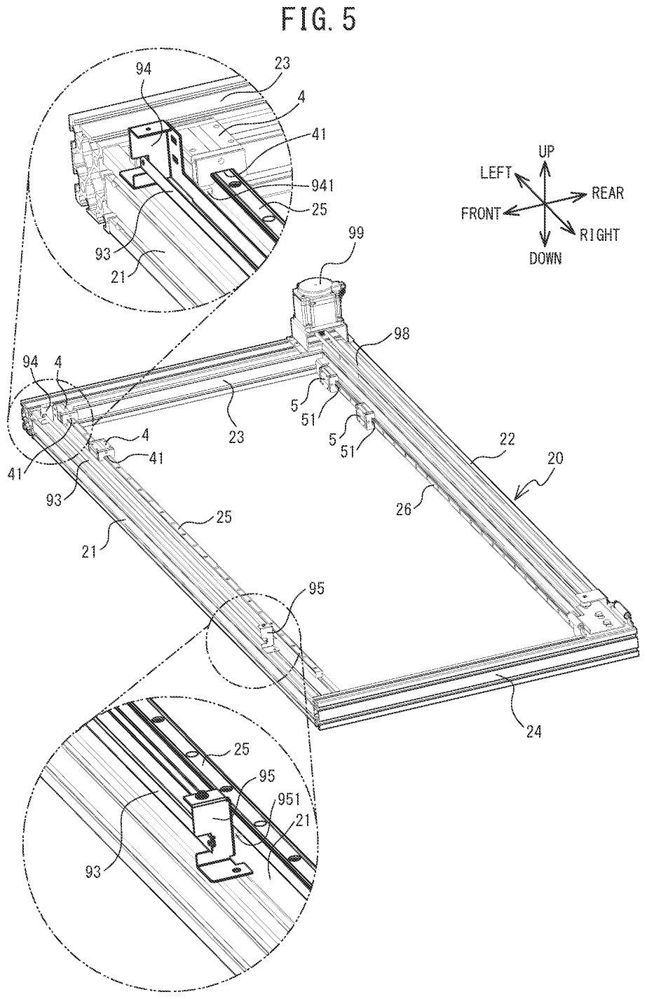

The specific structure of the guide shaft 20 will be described with reference to FIG. 2 to FIG. 5. As shown in FIG. 4 and FIG. 5, a front linear guide rail 25 is provided on the upper surface of the front shaft 21. The front linear guide rail 25 protrudes upward from the side to the rear of the center of the front shaft 21 in the front-rear direction, and extends in the left-right direction from the left end portion to the right end portion of the front shaft 21. The length in the front-rear direction of the center portion in the up-down direction of the front linear guide rail 25 is shorter than both the length in the front-rear direction of the upper end portion of the front linear guide rail 25 and the length in the front-rear direction of the lower end portion of the front linear guide rail 25.

Two front linear guide blocks 4 are provided on the front linear guide rail 25. The two front linear guide blocks 4 are lined up with each other in the left-right direction. An opening 41 is provided in each of the front linear guide blocks 4. The openings 41 open downward and pass through the front linear guide blocks 4 in the left-right direction. The shape of the openings 41 in a cross-section of the front linear guide blocks 4 corresponds to the outer shape of the cross-section of the front linear guide rail 25.

Each of the two front linear guide blocks 4 engages with the front linear guide rail 25 by the front linear guide rail 25 fitting inside the openings 41. As a result, the front linear guide blocks 4 can move along the front linear guide rail 25, and are positioned in the front-rear direction with respect to the front linear guide rail 25.

As shown in FIG. 4, the front fixing plate 73 is fixed to the upper surface of each of the two front linear guide blocks 4. Therefore, because the front linear guide blocks 4 are positioned in the front-rear direction with respect to the front linear guide rail 25, the carriage 6 and the heads 31 to 36 are also positioned in the front-rear direction with respect to the front linear guide rail 25. The two front linear guide blocks 4 are in positions P1 and P2, respectively, shown in FIG. 3, with respect to the front fixing plate 73. The position P1 is a left end portion of the front fixing plate 73. The position P2 is a right end portion of the front fixing plate 73.

A linear encoder 91 is provided on the front side of the front linear guide blocks 4. The linear encoder 91 is fixed to the front fixing plate 73. Therefore, the linear encoder 91 is fixed with respect to the front linear guide blocks 4. More specifically, the linear encoder 91 is at a position P3 shown in FIG. 3. The position P3 is between the positions P1 and P2 in the left-right direction. The linear encoder 91 is a reflective optical sensor, and is provided with a light emitting unit and a light receiving unit (not shown in the drawings). The light emitting unit and the light receiving unit of the linear encoder 91 both face an encoder strip 93 from the front side.

As shown in FIG. 5, the encoder strip 93 has a strip shape and extends in the left-right direction from the left end portion to the right end portion of the front shaft 21 on the front side of the front linear guide rail 25. That is, the encoder strip 93 extends along the front linear guide rail 25. On the front surface of the encoder strip 93, reflective regions having different light reflectances are arranged alternately in the left-right direction. With the linear encoder 91, light is irradiated from the light emitting unit at the encoder strip 93 and the light reflected by the reflective region of the encoder strip 93 is received by the light receiving unit. The linear encoder 91 detects the position in the left-right direction of the carriage 6 shown in FIG. 3 on the basis of the intensity of the light received by the light receiving unit.

The left and right end portions of the encoder strip 93 are supported by support members 94 and 95, respectively. Contact portions 941 and 951 are provided on lower end portions of the support members 94 and 95, respectively. The contact portion 941 protrudes toward the rear from the support member 94, and abuts against, and is fixed to, the left end portion of the front linear guide rail 25. The contact portion 951 protrudes toward the rear from the support member 95, and abuts against, and is fixed to, the right end portion of the front linear guide rail 25. As a result, the support members 94 and 95 are positioned in the front-rear direction with respect to the front linear guide rail 25.

As shown in FIG. 2, the encoder strip 93 shown in FIG. 5 is covered from the front and above by a cover 96. The cover 96 extends in the left-right direction from the support member 94 to the support member 95 shown in FIG. 5.

As shown in FIG. 4 and FIG. 5, a rear linear guide rail 26 is provided on the front surface of the rear shaft 22. The rear linear guide rail 26 protrudes forward from the side below the center of the rear shaft 22 in the up-down direction, and extends in the left-right direction from the left end portion to the right end portion of the rear shaft 22. Therefore, the rear linear guide rail 26 extends parallel to the front linear guide rail 25 on the rear side of the front linear guide rail 25. The length in the up-down direction of the center portion in the front-rear direction of the rear linear guide rail 26 is shorter than both the length in the up-down direction of the front end portion of the rear linear guide rail 26 and the length in the up-down direction of the rear end portion of the rear linear guide rail 26.

Two rear linear guide blocks 5 are provided on the rear linear guide rail 26. The two rear linear guide blocks 5 are lined up with each other in the left-right direction. An opening 51 is provided in each of the rear linear guide blocks 5. The openings 51 open toward the rear and pass through the rear linear guide blocks 5 in the left-right direction. The shape of the openings 51 in a cross-section of the rear linear guide blocks 5 corresponds to the outer shape of the cross-section of the rear linear guide rail 26.

Each of the two rear linear guide blocks 5 engages with the rear linear guide rail 26 by the rear linear guide rail 26 fitting inside the openings 51. As a result, the rear linear guide blocks 5 can move along the rear linear guide rail 26, and are positioned in the up-down direction with respect to the rear linear guide rail 26.

As shown in FIG. 4, the rear fixing plate 74 is fixed to the front surface of each of the two rear linear guide blocks 5. Therefore, because the rear linear guide blocks 5 are positioned in the up-down direction with respect to the rear linear guide rail 26, the carriage 6 and the heads 31 to 36 are also positioned in the up-down direction with respect to the rear linear guide rail 26. The two rear linear guide blocks 5 are in positions P4 and P5, respectively, shown in FIG. 3, with respect to the rear fixing plate 74. The position P4 is a left end portion of the rear fixing plate 74. The position P5 is a right end portion of the rear fixing plate 74.

According to the structure described above, as shown in FIG. 3, a control unit (not shown in the drawings) of the printer 1 controls the main scanning motor 99 on the basis of the position in the left-right direction of the carriage 6 detected by the linear encoder 91 shown in FIG. 4. In this case, when the driving force of the main scanning motor 99 is transmitted to the carriage 6 via the drive belt 98, the front linear guide blocks 4 and the rear linear guide blocks 5 shown in FIG. 5 move along the front linear guide rail 25 and the rear linear guide rail 26, respectively. As a result, the carriage 6 moves along the front shaft 21 and the rear shaft 22. That is, the heads 31 to 36 move in the left-right direction (the main scanning direction).

As described above, the carriage 6 is positioned in the front-rear direction by the front linear guide blocks 4, and positioned in the up-down direction by the rear linear guide blocks 5. Therefore, when the carriage 6 moves in the left-right direction (the main scanning direction), the carriage 6 is inhibited from moving in the front-rear direction and the up-down direction with respect to the front linear guide rail 25 and the rear linear guide rail 26. Therefore, the printer 1 enables the actual position where the liquid lands on the print medium to be inhibited from deviating from the liquid landing target.

When the heads 31, 33, 34, and 36 that discharge ink are mounted on the mounting portions 61 to 66 as in the embodiment described above, the actual position where the ink lands on the print medium is inhibited from deviating from the ink landing target. Therefore, the printer 1 is able to suitably form a base on the print medium, and is able to suitably print a color image. Accordingly, a decrease in the quality of the color image can be inhibited.

The front linear guide blocks 4 engage with the front linear guide rail 25 by the front linear guide rail 25 fitting into the openings 41, and the rear linear guide blocks 5 engage with the rear linear guide rail 26 by the rear linear guide rail 26 fitting into the openings 51. As a result, the precision of positioning of the carriage 6 in the front-rear direction and the up-down direction improves. Accordingly, the printer 1 can inhibit the actual position where the liquid lands on the medium from deviating from the liquid landing target.

When handling the linear encoder 91, the operator stands in front of (on the front side of) the printer 1 and opens the lid 11 with respect to the case 10. In this case, the lid 11 opens in the clockwise direction when viewed from the right side, with the rear end of the lid 11 serving as the axis. Because the front linear guide blocks 4 are positioned forward of the rear linear guide blocks 5, the distance between the operator and the linear encoder 91 is closer when the linear encoder 91 is provided on the front linear guide blocks 4 than when the linear encoder 91 is provided on the rear linear guide blocks 5. With the printer 1, the linear encoder 91 is provided on the front linear guide blocks 4, so the operator can handle the linear encoder 91 easier than if the linear encoder 91 were provided on the rear linear guide blocks 5. Therefore, work such as cleaning or replacing the linear encoder 91 is easier.

If the opening 41 were open toward the front, i.e., if the front linear guide blocks 4 were provided to the rear of the front shaft 21, the linear encoder 91 would be disposed between the front shaft 21 and the front extension plate 72 in the front-rear direction. If the opening 41 were open to the rear, i.e., if the front linear guide blocks 4 were provided in front of the front shaft 21, the linear encoder 91 would be disposed between the front shaft 21 and the case 10 in the front-rear direction. In these cases, the operator would have difficulty accessing the linear encoder 91, so the linear encoder 91 would be difficult to handle. However, with the printer 1, the opening 41 opens downward, i.e., the front linear guide blocks 4 are provided above the front shaft 21, so the linear encoder 91 is in a position it which it is not sandwiched by the front extension plate 72 or the case 10 and the front shaft 21. Therefore, with the printer 1, the operator can easily handle the linear encoder 91.

The deviation between the actual position of the head in the left-right direction and the position of the carriage 6 in the left-right direction detected by the linear encoder 91 becomes smaller as the distance from the linear encoder 91 to the head becomes closer. With the printer 1, the distance from the linear encoder 91 becomes closer in the order of the head 31, the head 32, and the head 33, and in the order of the head 34, the head 35, and the head 36. Therefore, the printer 1 is able to inhibit a deviation between the actual positions of the heads 33 and 36 in the left-right direction and the position of the carriage 6 in the left-right direction detected by the linear encoder 91. With the printer 1, the heads 31, 32, 34, and 35 discharge the white ink or the discharge agent and the heads 33 and 36 discharge the color ink. Therefore, the printer 1 can inhibit the actual landing position of the color ink in the left-right direction onto the medium from deviating from the landing target of the color ink, and thus can inhibit a decrease in image quality of the color image. Note that even if the landing position of the white ink or the discharge agent in the left-right direction were to deviate from the landing target of the white ink or discharge agent, the white ink or the discharge agent is used as a base and thus would not affect the image quality of the color image as much as if the landing position of the color ink were off.

The linear encoder 91 is provided on the front linear guide rail 25 side, and the main scanning motor 99 is provided on the rear linear guide rail 26 side. Therefore, vibration from the driving of the main scanning motor 99 is not as easily transmitted to the linear encoder 91 as it would be if the linear encoder 91 and the main scanning motor 99 were provided on the same side. Accordingly, the printer 1 can more accurately detect the position of the carriage 6 in the left-right direction with the linear encoder 91.

The present disclosure may be modified in various ways from the above embodiment. The various modified examples described below can be combined as long as there are no contradictions. The present disclosure is not limited to the printer 1, and can also be applied to a pretreatment agent discharge device, for example. The pretreatment agent discharge device is provided with a head for discharging a pretreatment agent. The pretreatment agent is a liquid for improving ink fixing and color development, etc., and is discharged onto a medium before printing.

In the foregoing embodiment, the front linear guide rail 25 and the rear linear guide rail 26 need not extend in the left-right direction, and may instead extend in the up-down direction or the front-rear direction, for example. In this case, the heads 31 to 36 may discharge the liquid forward or toward the rear. In this case, the platen 12 is provided in a position facing the heads 31 to 36 from the front or the rear.

In the foregoing embodiment, the front linear guide rail 25 need not be provided on the upper surface of the front shaft 21, and may instead be provided on the front surface, the lower surface, or the rear surface of the front shaft 21, for example. For example, when the front linear guide rail 25 is provided on the front surface of the front shaft 21, the plate need simply extend farther downward from the front end of the front fixing plate 73. The rear linear guide rail 26 need not be provided on the front surface of the rear shaft 22, and may instead be provided on the upper surface, the lower surface, or the rear surface of the rear shaft 22. The surface of the front shaft 21 on which the front linear guide rail 25 is provided and the surface of the rear shaft 22 on which the rear linear guide rail 26 is provided need only face in directions orthogonal to each other. That is, the front linear guide blocks 4 and the rear linear guide blocks 5 need only engage with the front linear guide rail 25 and the rear linear guide rail 26, respectively, such that the openings 41 and 51 face in directions orthogonal to each other.

In the foregoing embodiment, the front shaft 21 and the rear shaft 22 themselves may have the functions of the front linear guide rail 25 and the rear linear guide rail 26, respectively. That is, the front linear guide blocks 4 and the rear linear guide blocks 5 may engage with the front linear guide rail 25 and the rear linear guide rail 26, respectively.

In the foregoing embodiment, the front linear guide rail 25 and the rear linear guide rail 26 protrude from the upper surface of the front shaft 21 and the front surface of the rear shaft 22, respectively. However, the front linear guide rail 25 and the rear linear guide rail 26 may instead be recessed from the upper surface of the front shaft 21 and the front surface of the rear shaft 22, respectively. In this case, the front linear guide blocks 4 and the rear linear guide blocks 5 may have protruding shapes and fit into recesses of the front shaft 21 and the rear shaft 22, respectively. That is, the shapes of the front linear guide blocks 4 and the rear linear guide blocks 5 are not limited to the foregoing embodiment. The front linear guide blocks 4 may have a flat plate shape or the like as long as they can position the carriage 6 in the front-rear direction. The rear linear guide blocks 5 may have a flat plate shape or the like as long as they have a shape that enables them to position the carriage 6 in the up-down direction. In the foregoing embodiment, the number the front linear guide blocks 4 and the number of the rear linear guide blocks 5 are not limited to two each, and may be 1 or three or more each.

In the foregoing embodiment, the linear encoder 91 need not be fixed to the front linear guide blocks 4, and may instead be fixed to the rear linear guide blocks 5, for example. In this case, the encoder strip 93 need only be provided on the front surface of the rear shaft 22. The linear encoder 91 may be directly fixed to the front linear guide blocks 4 instead of being fixed to the front fixing plate 73. The linear encoder 91 is not limited to a reflective optical sensor and may instead be a transmissive optical sensor. In this case, the light emitting unit and the light receiving unit of the linear encoder 91 need only face each other in the front-rear direction across the encoder strip 93.

In the foregoing embodiment, the heads 31 to 36 are mounted to all of the mounting portions 61 to 66, respectively. However, only some of the heads 31 to 36, for example, only the heads 31, 33, 34, and 36 when the discharge agent is unnecessary for printing, may be mounted to the mounting portions 61, 63, 64, and 66, or one may be mounted on any one of the mounting portions 61 to 66. The number of the mounting portions 61 to 66 is not limited to six, as long as it is at least one.

In the foregoing embodiment, the type of liquid discharged from each of the heads 31 to 36 is not limited to the foregoing embodiment. For example, the heads 31 and 34 may discharge a color ink, the heads 32 and 35 may discharge a discharge agent, and the heads 33 and 36 may discharge white ink. In the foregoing embodiment, the main scanning motor 99 need not be provided on the rear shaft 22, and may instead be provided on the front shaft 21, for example.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A liquid discharge device comprising:
a first rail extending in a first direction,
a first block configured to move along the first rail,
a second rail provided in a second direction orthogonal to the first direction with respect to the first rail and extending in the first direction,
a second block configured to move along the second rail, and
a carriage fixed to the first block and the second block and provided with a head configured to discharge a liquid onto a medium,
wherein one of the first block and the second block positions the carriage in the second direction, and
wherein the other of the first block and the second block positions the carriage in a third direction orthogonal to the first direction and the second direction.

2. The liquid discharge device according to claim 1, wherein
a first opening into which the first rail fits is provided in the first block,
a second opening into which the second rail fits is provided in the second block,
one of the first opening and the second opening faces in the third direction, and
the other of the first opening and the second opening faces in the second direction.

3. The liquid discharge device according to claim 2, further comprising:
a linear encoder fixed with respect to the first block and configured to detect the position of the carriage in the first direction,
wherein the first direction and the second direction are parallel to the horizontal direction.

4. The liquid discharge device according to claim 3, wherein
the third direction is vertically downward,
the first opening faces in the third direction, and
the second opening faces in the second direction.

5. The liquid discharge device according to claim 3, wherein
a plurality of the heads are provided on the carriage,
the plurality of heads include a first head configured to discharge, onto the medium, a base liquid, the base liquid being the liquid configured to form a base, and a second head configured to discharge, onto the base, a color ink, the color ink being the liquid configured to print a color image, and
the second head is positioned in the second direction with respect to the first head.
